(19) United States
(12) Patent Application Publication
(10) Pub. No.: US 2018/0001570 A1
(43) Pub. Date: Jan. 4, 2018

(54) Authentication, Testing and Certification of Additive Manufactured Items and Cryogenically Processed Additive Manufactured Items

(71) Applicant: Jack Cahn, Boulder, CO (US)

(72) Inventor: Jack Cahn, Boulder, CO (US)

(21) Appl. No.: 15/626,102

(22) Filed: Jun. 17, 2017

Related U.S. Application Data
(60) Provisional application No. 62/353,641, filed on Jun. 23, 2016.

(51) Int. Cl. B29C 64/393; B33Y 50/02; G05B 19/4099

(52) U.S. Cl. CPC B29C 64/393; G05B 19/4099; B33Y 50/02; G05B 2219/49007; G05B 2219/35134

(57) ABSTRACT

Embodiments describe a means to authenticate manufacture of AM parts to a third party using witness artifacts. Embodiments describe cryogenic processing of additive manufactured (AM) metal and metal-matrix items to improve mechanical, physical, electrical, and/or chemical properties. Embodiments also describe a method of scientific testing and engineering analysis that validate cryogenically treated, AM items by measuring and contrasting enhancements in wear, corrosion, fracture, fatigue, and electro-chemical properties against baseline samples. Embodiments also describe a certification method, using a MIL-STD format digitized or written report that outputs a standards-based, First Article Test report and certification statement. The embodiments describe a lean processing method and value stream map that captures defects and identifies and segregates discrepant parts along with proxy witness test samples. Embodiments also describe an archival storage method of authenticated, validated, and certified artifacts, identical in material alloy and metallurgical characteristics to the in-use AM part, that meet AS9100 ISO quality standards for such critical applications as space flight, military, FDA, medical, nuclear, and civilian aviation.

### CROSS-REFERENCES

This application claims priority from U.S. Provisional Patent Application No. 62/353,641, filed Jun. 23, 2016, entitled, “PROCESS AND METHOD FOR AUTHENTICATION, TESTING, VALIDATION AND CERTIFICATION OF ADDITIVE MANUFACTURED ITEMS AND CRYOGENICALLY PROCESSED ADDITIVE MANUFACTURED ITEMS FOR MILITARY, COMMERCIAL AND INDUSTRIAL USE”, which is incorporated by reference, as if set forth in full in this document, for all purposes.

### FIELD

Embodiments of the present invention relates generally to additive manufacturing (AM) and cryogenic processing of materials and, more particularly, to authentication, testing, and certification of AM and cryogenically treated AM metal and metal-matrix items.

### BACKGROUND

Metal items are commonly used in a variety of commercial, industrial, and military applications. Platforms such as ships, planes, automobiles, and trains are made of many systems and assemblies that require metal items. Other key platforms include power generating systems (gas, coal, and nuclear), oil and gas exploration equipment, and complex industrial machinery. Many of the parts in these platforms are subject to wear, fatigue, corrosion, and other use or environmental factors that degrade their performance over time.

Historically, metal parts have been made via forging, casting, milling, turning, fabricating, and other manufacturing processes by removing, pressing, shaping, forming, melting, machining, or otherwise altering the raw metal billet or ingot into a final shape. These processes are often referred to as “subtractive manufacturing” because they create a final shape that is smaller than the original and because they create that shape by reducing, removing, or subtracting material.

AM is a relatively new manufacturing technique that uses a directed energy heat source such as a laser or electron beam to fuse, melt, sinter, or combine small particles, thin wire, powder, liquid, or gaseous metallic elements into a final shape that is larger than the original powder grains or particles from which it was formed.

AM is also known as 3-D printing, 3-D metal forming, powder metal deposition, direct metal laser sintering (DMLS), direct metal laser melting (DMLM), electron beam additive manufacturing (EBAM), metal deposition, and dual wire additive manufacturing (DWAM).

AM has significant advantages over subtractive manufacturing methods, including lower cost to manufacture small quantities, quick revision capability, short production lead time, elimination of need for form dies or tooling, the ability to construct unrestrained free-form geometry, closed loop feedback for dynamic process measurement, multiple blended material composition and custom feature creation of a different alloy than used for the primary matrix structure.

There is incomplete knowledge on the mechanical, electrical, physical, and chemical properties of AM items regarding both their overall metallurgical characteristics as well as their wear, corrosion, fatigue, fracture, electro-chemical, and other performance properties specific to long term. This lack of data and knowledge has somewhat limited both acceptance and use of AM parts in critical and safety-oriented applications.

Numerous standards and procedures exist, both industrial (e.g., SAE, AMS, ASTM, ANSI) and military (e.g., MIL-STD, MIL-SPEC, MIL-PRF) governing acceptable test, authentication, validation, and certification methods for subtractive manufacturing processes. However, there are no such industrial, military, or defined engineering protocols governing test, authentication, validation, and certification of AM produced items.

Cryogenic processing is a cold treatment process employed on plastics, metal, and metal-matrix items to improve wear, corrosion, fatigue resistance, and other properties. The process is known to impart permanent enhancement of metallurgical properties and extend both performance ceiling and lifespan of treated parts.

There are several methods of treating parts, generally involving dry gaseous, wet immersion, or a combination of the two. Treatment chambers are generally rectangular or round in shape, holding between 10-2000 pounds of parts and approximately 3′×3′×6′ or 3′×5′ diameter in size. The cryogen employed is primarily liquid nitrogen due to cost, efficiency, availability, and safe handling characteristics.

Processing protocols for cryogenic or deep cryogenic treatment usually involve several linked steps: a slow ramp down in temperature, a cold-constant temperature between −260° F. and −320° F. at a maintained low degree (sometimes called a cold “soak” regardless if dry or immersed in liquid nitrogen), a slow ramp up in temperature to ambient temperature and between 1-5 cycles of post-cryogenic annealing. The total length of processing time is between 30-112 hours based on material alloy, characteristics being enhanced, and multiple factors involving the physics of thermal transfer of latent heat. Some of these techniques and protocols are described in U.S. Pat. No. 3,891,477 issued June 1975 to Lance; U.S. Pat. No. 5,865,913 issued February 1999 to Paulin, et. al; U.S. Pat. No. 5,259,200 issued November 1993 to Karmody; U.S. Pat. No. 4,739,622 issued April 1988 to Smith; U.S. Pat. No. 5,174,122 issued December 1992 to Levine.

Theoretically, processing protocols are based on total weight and mass of objects being treated, alloy or material type, specific gravity/density, relevant time and temperature curves to achieve necessary improvements, machine design, capability, and annealing requirements. However, the manufacturers of deep cryogenic or cryogenic treatment equipment do not generally conduct, rely upon, or base treatment profiles on finite element analysis, engineering, academic, applied science, or any parametric data that ties or relates a fixed treatment protocol to specific results for materials, enhancements desired, or actual operating parameters. They generally create pre-set protocols in the programmable logic controller (PLC) that may or may not benefit the item being treated. Since no cryogenic treatment service provider currently in operation, known to this inventor, conducts scientific-based research and development, operates scientific test equipment to evaluate and confirm processing results, links each treatment to actual results obtained or correlates these results, the protocols used are not quantitatively or empirically linked to the results obtained via the scientific process.

The current state of the art, known to this inventor, of authentication, validation, and/or certification of cryogenically treated items, AM or otherwise produced, is the issuance of a simple payment receipt and/or possibly an unverified statement that an object has been cryogenically treated. There is no test, measurement, inspection, data collection, or other scientific, engineering, or formalized procedure that a) confirms metallurgical change to the cryogenically treated item, b) measures and/or records the level of improvement in one or more characteristics, hence validating a level of benefits, or c) certifies the treatment and/or results against a known or oversight industry or military standard, providing any data or certificate that is acceptable to a third party not present at time of treatment.

Although there are numerous commercial and industrial standards (e.g., ASTM, SME, ASM), military standards (MIL-STD, MIL-SPEC, MIL-PRF) and international test or quality standards (e.g., ISO, AS) that govern heat treating surface treatments with defined inspection and test procedures, there exists no such standard, known to this inventor, governing or outlining authentication, validation, or certification procedures for cryogenic processing of metal parts.

### BRIEF SUMMARY

Among other things, embodiments described herein provide systems, procedures, methods, and establish a standard for authentication, testing and certification of additive manufactured and cryogenically treated additive manufactured parts. According to the embodiment described within, the authentication, testing and certification procedures are based on scientific data obtained through destructive and/or non-destructive testing of artifacts. Some embodiments state that a part created all, in-part, or predominantly by additive manufacturing exhibits specific metallurgical characteristics that are found in artifacts created almost simultaneously with the referenced part and that, by testing and measuring the artifact against known standards, one can authenticate the part by virtue of the testing conducted on the proxy artifacts. After such confirmation testing, the part itself may be considered authenticated. After validating the artifact using the procedure described within, the referenced part may be considered validated. After certifying the artifact using the procedures described within, the referenced part maybe considered certified.

Some embodiments state that a part created all, in-part, or predominately by additive manufacturing, which is then cryogenically treated, exhibits specific metallurgical characteristics that are found in artifacts created almost simultaneously with the referenced part and that, by testing and measuring the artifact against known standards, one can authenticate the part by virtue of the testing conducted on the proxy artifact. After such confirmation testing the part itself may be considered authenticated, along with the authenticated artifact.

Some embodiments state that an article or part that has been additive manufactured, cryogenically treated, and authenticated can be validated by comparing and contrasting, through scientific measurement, the metallurgical characteristics found in the authenticated, additive manufactured cryogenically treated witness artifacts against those characteristics in the authenticated, additive manufactured (but non-cryogenically treated) artifacts and then compared to and validated by known standards. In this manner, one may validate the referenced part by virtue of the validation procedure conducted on the proxy artifacts and proxy witness artifacts

some embodiments state that an article or part that has been additive manufactured, cryogenically treated, and validated can be certified by issuing digital or written certificates that hold the validation results against the known acceptable standards for validation and certification and thereby document and archive such certification as a permanent record. In this manner, one may certify the validated reference part by virtue of the certification procedure conducted on the proxy artifacts and proxy witness artifacts.

### BRIEF DESCRIPTION OF THE DRAWINGS

The present disclosure is described in conjunction with the appended figures:

FIG. 1 shows a flow diagram of the AM process according to various embodiments including preliminary, AM, inspection intervals, testing steps, cryogenic processing authentication, validation, certification, post-processing, and outbound.

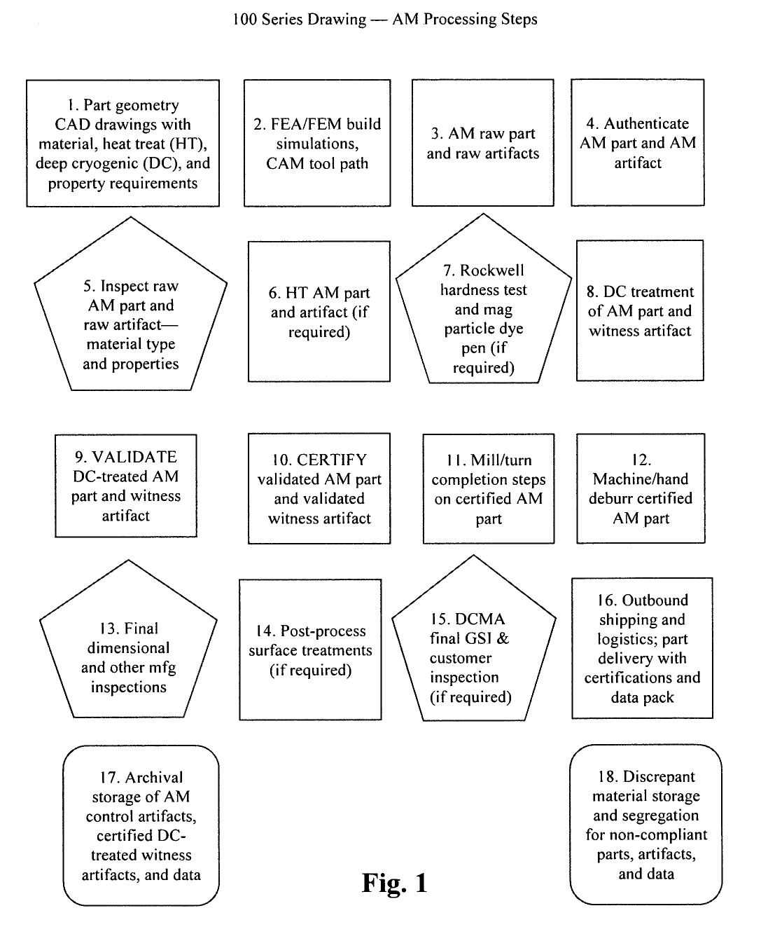

FIG. 2 shows a flow diagram of a method of producing AM artifacts and embodiments displaying authentication, validation, and certification procedural steps.

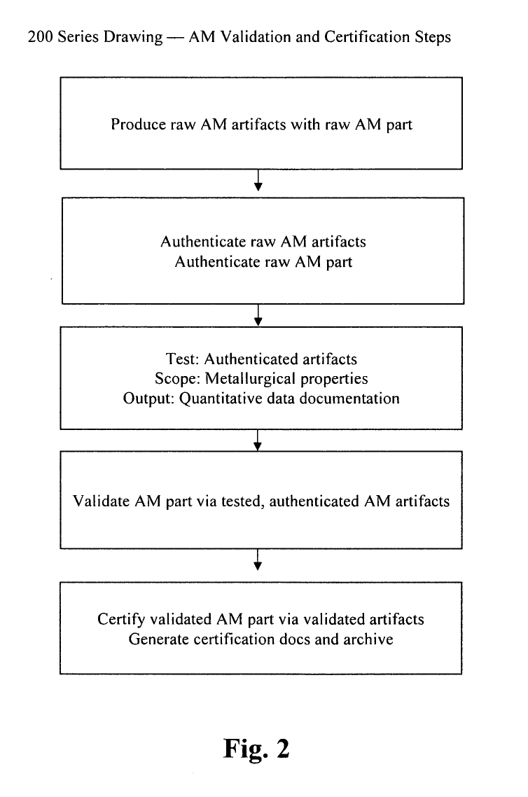

FIG. 3 shows a flow diagram of a method of producing AM cryogenically treated artifacts and witness artifacts and embodiments displaying validation and certification procedural steps.

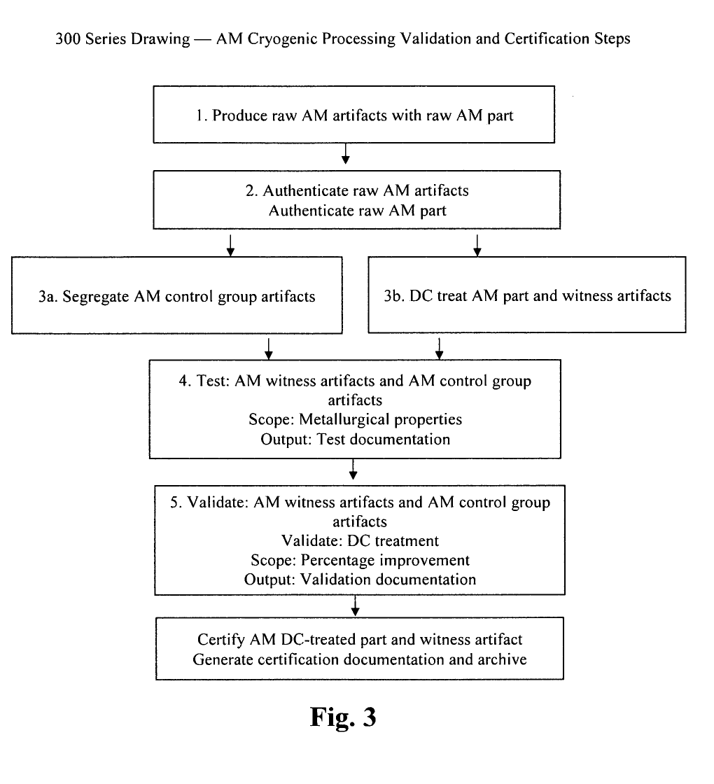

FIG. 4A shows an illustration of a method of producing AM artifacts co-joined to the additive manufacture part via a breakaway tab or other connecting geometry.

FIG. 4B shows an illustration of a method of producing AM artifacts co-joined to each other (but not to the AM part) via a breakaway tab or other connecting geometry.

FIG. 4C shows an illustration of a method of producing AM artifacts free-standing and independent of other artifacts or the AM part.

### DETAILED DESCRIPTION

In the following description, numerous specific details are set forth to provide a thorough understanding of the present invention. However, one having ordinary skill in the art should recognize that the invention may be practiced without these specific details. In some instances, configurations, procedures, and techniques have not been shown in detail to avoid obscuring the present invention.

Various techniques are known for creating AM parts. Typically, these techniques involve use of a directed energy source such as a laser or electron beam to melt, sinter, fuse, or combine discrete powder, liquid, gas, or wire-fed material into a superheated plasma that, upon cooling, phase changes into a solid. This material is then built, layered, and/or increased in size through subsequent heat-influenced meltings that eventually increase in size to the final form and geometry. The AM part may be created alone, free-standing and independent of any prior or pre-form geometric shape, additive, or subtractive manufactured. The AM part may also be created prior to or post a shape that is generated by another manufacturing method in partial or final geometric form and dimension.

In some embodiments, AM is preferred over traditional manufacturing methods due to its ability to construct freeform geometric structures and various material thickness, non-Euclidean outer forms without solid structural members, or external work holding restraints necessary in milling, turning, or fabricating. Other embodiments describe the use of AM to eliminate construction of forging dies or casting tools that add engineering and build time, greater cost, a qualification process, and generally necessitate additional machining steps.

Some embodiments describe the elimination of die construction, reduction in both labor time and cost, and a lowering of risk of missed deliveries or unacceptable part deviation by employing AM, as in-line with theoretical “best practice” of lean manufacturing practices or value stream mapping optimization—the operational goal of almost all ISO 9001 and AS 9100 Quality Management systems. Other embodiments advance use of AM as a low-cost, high tech, accessible disruptive manufacturing method that enables a resurgence of US manufacturing efforts based on the computer literate skills of the current generation over the apprenticeship, journeyman, and skill acquisition methods of past generations.

Although AM offers numerous design, production, cost, technical, and delivery advantages, the lack of metallurgical data on final form AM parts along with no standards or prescribed authentication, validation, and certification methods has slowed and/or restricted use of AM across many commercial, industrial, and military applications.

Currently, both producers and end-users of AM parts rely on non-AM-specific standard based means for part acceptance and approval. Material analysis may be based on prior chemical/physical certificate issued by the origin manufacturer of the raw material or powder, however, once the powder is exposed to the AM directed energy and changes shape, phase, or form via melting, liquefaction, or sintering, the resulting matrix is altered in the mechanical, electrical, physical, and/or chemical properties do not replicate those necessarily stated on the chem/phys certificate issued by the manufacturer of the powder. Since the powder form cannot be tested by the battery of tests necessary to meet end-use operational function for most applications, dynamic use metallurgical information is incomplete.

Embodiments described within of a standard-based method to authenticate, validate, and certify AM parts to follow a NIST-traceable, ITAR compliant, ISO 9001 and AS 9100 Quality Management system format. Such embodiments also follow military acceptance standard format used by the DCMA and DOD quality assurance representatives for MIL-STD based First Article Test (FAT) procedures, C=0 statistical sampling plans, and origin and destination US government contract inspection and acceptance protocols.

The embodiments describe production of artifacts created immediately before, simultaneous to, or immediately after production of an AM part using the same AM machine, directed energy source, composition, and type of raw material (whether powder/solid, liquid, or gas) and AM tool path geometry software, hardware, computer control, and electronic connection as that used in AM of the referenced part.

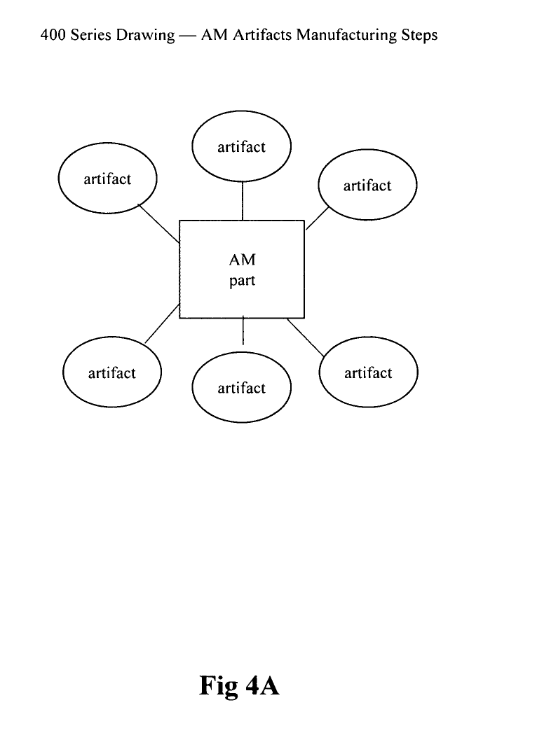

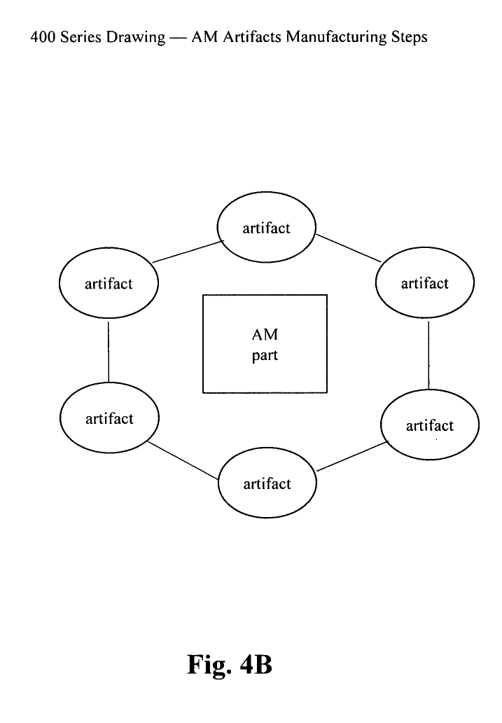

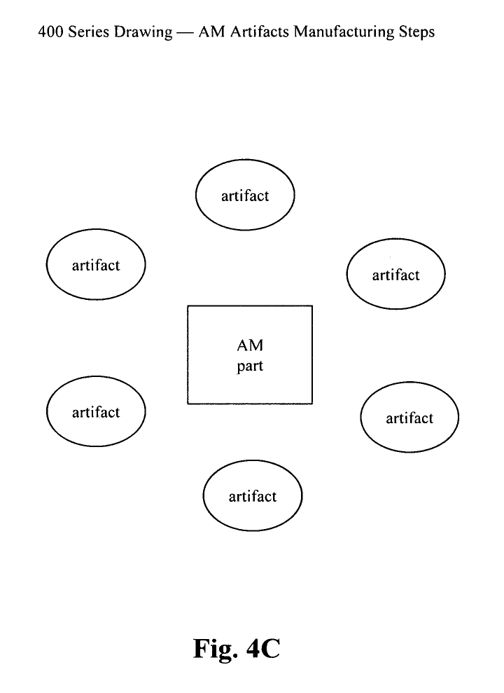

FIG. 4A illustrates embodiments of artifact creation physically attached or connected to the reference part being AM-constructed via a material union or breakaway tab that may facilitate orderly removal of the artifact but also physically links and confirms simultaneous AM of both piece (referenced) part and artifact for traceability.

FIG. 4B illustrates embodiments of artifact creation physically attached or connected to the other artifacts but not to the referenced part. This method may be employed when geometry specifics of the actual part do not support attachment directly to every artifact. However, embodiments contained within also describe situations where one or more artifacts may physically attach to the referenced part while the remainder of artifacts only physically connect to other artifacts.

FIG. 4C illustrates embodiments of artifact creation in which an artifact is AM meeting these or all of the conditions of (0034) but is not physically connected to or attached to either the referenced part or other artifacts.

The artifact may or may not be AM produced with part number, National Stock Number, or other identifying number, symbol, mark, or stamp visible or invisible and such identification may or may not be affixed or placed on the part or artifact at a later time via manual, robotic, machine application, electro-chemical or other means to identify the part, assembly, contract, procurement, manufacturer, or CAGE code.

Embodiments describe a method of artifact authentication that directly link production of the artifact to the piece part, using the same AM equipment, production method, raw material, time/date stamping procedures, and construction parameters, so as to create coupons for destructive and non-destructive standards-based testing that serve as proxy for the actual referenced part or a duplicate part redundantly produced, or testing of alternate material or for authentication, validation, and certification without testing of an artifact for the reasons outlined in (0039-0048).

The artifacts can be produced in multiple, simultaneous copy during AM part construction, offering authentication, validation, and certification opportunities at different and/or sequential secondary manufacturing or surface treatment steps, however; all can be traceable to the piece part and still meet AS9100 or ISO flow down requirements. This embodiment also promotes volume, redundant testing of artifacts, reducing scatter and statistical margin of error—allowing result calibration at mean, medium, or mode with greater accuracy.

The embodiment permits permanent and archival storage of artifacts stored on- or off-site of manufacturing and/or testing—this allows longitudinal testing or follow-on testing long after part production, inventory, or use—especially valuable for technology advances and testing methods, equipment, or dynamic test scenarios not understood, available, or considered at time of original part manufacturing or use.

Artifact testing allows robust testing of mechanical, electrical, and chemical characteristics on proxy artifacts for delicate structural or fragile geometric AM parts that are unable to withstand dynamic testing and whose performance under load would be otherwise not understood. This is especially useful for space-based or high G-force experienced AM parts in that artifacts with identical features, considered at risk for space flight, can be dynamically tested in proxy for expensive and long lead time instrument clusters containing and/or relying on AM structural components.

Certain destructive tests that are necessary to comprehensively chart and understand the metallurgical properties of an AM item require standards-defined form or shape (eg., notched bars for ASTM 3-point bend specimens to predict stress intensity factors for fatigue prediction fracture analysis, Charpy impact tests, round “dog bone” samples for tensile, ductile, or torsion deformation testing, flat plates for pin-on-disc or pin-on-plate tribological testing).

Inaccessible geometric features within an AM part, previously only finite element modeled for prediction analysis, can be generated in free-standing artifact form and comprehensively tested for functionality, strength, performance, fit/function, and/or dynamic life cycle.

Time sensitive AM replacement parts, not necessarily able to be tested at length due to need, remote location, or other factors, can have on-site artifact testing almost performed simultaneously to AM part manufacturing to expedite production while meeting test requirements.

The authenticated, validated, and certified artifacts can remain in chain-of-custody when industrial, military, legal, or international requirements demand such control.

Artifact testing can be performed under multiple national or international distinct test locations, allowing validation and certification to be internationally approved on an AM part. This embodiment also describes international or multi-national test, acceptance, and participation on space-based or inter-planetary missions using AM parts and/or dynamic or environmental testing performed on proxy artifacts in space (eg., the International Space Station or a Mars-based test facility) ahead of AM part deployment.

Embodiments provide for secured chain-of-custody and control on authenticated AM parts that are classified, sensitive, or are controlled by the US Government or DOD based on part material, geometry, purpose, or roll-up assembly function. This embodiment describes remote (unsecured) testing on non-classified, authenticated artifacts that, by proxy, serve to validate and certify classified AM parts that, due to restrictions based on their movement, might not otherwise be comprehensively tested, validated, approved, and/or certified without increased cost, time, or exposure.

Embodiments provide for AM parts, ultimately destined for operation in radio active, nuclear, biological, or chemical hazardous environments, that can be a attribute-tested, via proxy artifacts, in such hazardous environments for many static and dynamic situations without contaminating or compromising the AM part itself, in final or assembled form. Such artifacts that have been exposed to dangerous, hazardous, or contaminated environments can be potentially destroyed, contained, quarantined, transported, or secured far more easily because their small size (eg., 1″ diameter×¼″ thick) in proxy doesn't pose the challenges of some full-size AM parts (eg., rocket nozzles/exhaust cones, nuclear fuel rods, depleted uranium military items, high-level radioactive storage casks).

Embodiments describe the step or process of authentication as occurring commensurate with or immediately after the AM artifact has been positively linked to manufacture of the referenced AM part via embodiments described within. The embodiments may include time and/or date stamping, CAD or CAM tool path output code in digital, written, or visual form, expressed in binary, alphanumeric, or program language code, in any neutral forms such as ASCII or specific to a machine controller or language such as Fanuc, OS, Unix, or Windows.

Other embodiments might include photographic record or any method of material fingerprinting—which may be defined as any means of authenticating the atomic level similarity of metallurgical material between artifact and referenced part seen in atomic, sub-atomic, particle type, content, or grain level inspection.

For purpose of use in all embodiments advanced by this invention, the term “part,” “referenced part,” “item,” or “piece part” may be used interchangeably to mean an AM part.

Once authenticated, an AM artifact may be tested for metallurgical, mechanical, electrical, physical, or chemical characteristics with proxy association of the artifact results to the piece part.

The embodiments describe post-authentication testing that may occur at any point in creation of the final certified part. For example, testing may occur after heat treat, cryogenic processing, fixture removal, milling, turning, electrical discharge machining, inspection, or post-process surface treatments. Any, all, or none of these steps may be omitted, excluded, reordered, or substituted.

If cryogenic processing is not performed in production of the AM part, then the authenticated AM part is said to be validated after the necessary metallurgical tests are performed on the artifact and the test properties or characteristics of the artifact are proven to meet the acceptance criteria of the commercial, industrial, military, and/or quality standards by which the artifact or part is to be judged. The authenticated AM part is hence considered validated via validation of the proxy validated artifact.

If cryogenic processing is not performed in production of the AM part, then the validated part is said to be certified when the validated artifact conforms to one or more certification protocols. For example, certification protocols may include one or more of the following items: a Certificate of Conformance, First Article Test and Acceptance documentation, the military recognized ISO/AS registered or industrial defined certification document that properly, explicitly, or by reference outlines necessary conditions for the third-party acceptance.

Embodiments of such documentation may be based on or require NIST-traceable calibration and/or positive recall procedures, pre-defined minimum acceptance criteria, and documentation items such as part name, NSN, serial/part number, government contract, DPAS rating, buying agency or company, contact info, delivery, inspection, and buy-off criteria, quantity, lot info, classified status, roll-up levels or assemblies, means of/description of production, alternate acceptance criteria, inspection method, equipment used and calibration status, environmental or hazmat info, manufacturer/distributor/buyer/contract party/customer/military component CAGE codes, any DOD/DCMA or QAR inspection and acceptance info, RFID, military packaging and labeling data.

According you some embodiments, certification documents may be based or modeled on the general format of MIL-HDBK-831 Preparation of Test Reports, MIL-STD-105E Sampling Procedures for Inspection by Attributes, MIL-STD-1916 DOD Test Method Standards, or military First Article Tests or Certificates of Conformance.

In these embodiments, the output form of certification may be a written or digital (or both) certificate document that is issued by the manufacturer and/or authorized test facility approved to issue such a certification document. The document may be required to generate a First Article Test document or other necessary acceptance documents that state realization or measurement of certain metallurgical property requirements. The validated part is hence considered certified via certification of the proxy certified artifact. The proxy artifacts may then serve as physical certification examples of additive manufacturing, authentication, testing, and validation steps employed in production of the referenced AM part. This allows the unique ability to subject a certified proxy for redundant or additional testing after the AM part is already remote, installed, in-use, and/or possibly inaccessible.

If cryogenic processing is performed on the authenticated AM part, then the cryogenic process maybe employed to increase densification, reduce material fatigue or fracture properties, increase mechanical properties (eg., UTS, yield, or compressive strength), increase closer tolerance downstream machining, reduce potential corrosion sites or wear/corrosion effect, impart finer surface finish, lower particle delamination, increase electrochemical bonding effect, and decrease electrical resistance in conducting metals.

Specific embodiments of cryogenic processing that describe improvements to AM parts that have been cryogenically and/or deep cryogenically processed include increased strain hardening at upper and lower yield levels, optimized lattice structure performance under plastic deformation loads, increased local engineered mechanical strength, reduced non-metallic inclusions that often propagate as fatigue crack initiation sites, increased fracture resistance or toughness, increased creep strength under high cyclic load, reduction in undesirable porosity in nickel-based superalloys, and/or reduced brittle fracture over wider temperature operating ranges.

Primary embodiments of the deep cryogenic treatment process include retained austenite to martensite conversion without embrittlement, reduction in grain size with increased yield strength (Hall-Petch relationship), non-reversal precipitation of primary and secondary eta carbides, and reduction of porosity and voids.

The cryogenic processing protocols may be employed at any stage of manufacturing in an AM part, although some embodiments suggest cryogenic processing after heat treating.

Cryogenic processing and deep cryogenic processing are similar processes except that deep cryogenic processing usually requires slow temperature ramp down, more extended cold treatment, and slow ramp up cycles—all at maximum temperatures that are colder and time intervals that are longer than cryogenic processing. The results obtained by deep cryogenic processing tend to be permanent and at greater degrees of material and enhancement or effect than shallow cryogenic processing or cryogenic processing. Deep cryogenic processing typically requires or suggests 1-5 post-deep cryogenic treatment annealing cycles to eliminate hydrogen embrittlement—steps not necessarily taken or required for cryogenic processing.

All cryogenic and deep cryogenic treatment (herein jointly abbreviated as DCT) protocols or “recipes” are variable, based on total weight of treated part(s), part geometry, single or multiple materials in treatment lot, one or more metallurgical characteristics being enhanced, retained heat and items at start of cryogenic processing and/or DCT tank design, total volume/size and capability.

Embodiments suggest use of liquid nitrogen as a cryogen in a vacuum surround, dry vapor environment over immersion in a liquid or evaporative bath or chamber to eliminate harmful thermal shock and/or reduce or eliminate potential corrosion damage, metallurgical damage, or other effects caused by direct exposure to liquid phase liquid nitrogen or direct vapors from liquid nitrogen (eg., corrosion or surface rust from condensation or precipitation).

DCT tank design should not introduce external air into the tank during ramp up phase to prevent condensation on below-ambient temperature items. Round DCT chamber design or rounded corners are also preferable over square or rectangular DCT chambers to eliminate thermal losses, control temperature intervals more precisely, allow more even circulation over thermal mass being treated, and to prevent thermoclines in large volume chambers.

Embodiments describe the validation process of AM cryogenically treated parts as requiring a testing procedure in which a portion of the AM-authenticated artifacts are held in reserve and not subjected to cryogenic processing. These artifacts are called “control group artifacts” or “control artifacts.” The control artifacts are differentiated from the witness artifacts, those artifacts which accompany the referenced part through cryogenic processing, by their accurate representation of metallurgical, physical, mechanical, electrical, and chemical properties in the pre-cryogenic processing, “as authenticated” state. Control artifacts may or may not be segregated from the authenticated artifacts.

Witness artifacts are those AM-authenticated artifacts which have undergone cryogenic processing or DCT with the AM part or lot of parts being validated. Proof of actual DCT may include any written or digital load document, inventory, or description of treatment cycle; a photograph, video recording, or digital data file recording entry, treatment, and exit of witness artifact in DCT chamber; a thermocouple or transducer (direct) reading or charted record, and/or any combination of the above that meets commercial, industrial, or military defined acceptance protocols. These embodiments are not representative of all variations that represent proof of treatment.

Following cryogenic treatment, the control artifacts and witness artifacts may be subjected to a variety of mechanical, electrical, physical, and chemical tests, both destructive and non-destructive, to demonstrate improvement or change to metallurgical characteristics. In all embodiments, the control artifacts represent the metallurgical state of the referenced part prior to cryogenic treatment.

After testing, the results are compared and contrasted between control artifacts and witness artifacts. The analysis and results showing both definite change in one or more metallurgical properties and the degree of change from baseline (control artifact) may be incorporated into data that is used or added to a First Article Test report or formalized record that validates cryogenic treatment of the witness artifact and thus, via proxy relationship, validates cryogenic treatment of the referenced AM part. The authenticated AM part is hence considered validated through cryogenic or DCT processing by validation of the proxy validated witness artifact.

Embodiments described within that a validated AM cryogenically treated part is said to be certified when the validated witness artifact(s) conforms to one or more certification protocols. For example, certification protocols may include one or more of the following items: a Certificate of Conformance, First Article Test and Acceptance documentation, a military recognized ISO/AS registered or industrial defined certification document that properly, explicitly, or by reference outlines necessary conditions for third-party acceptance.

Embodiments of such documentation (0071) may be based on or require NIST-traceable calibration and/or positive recall procedures, pre-defined minimum acceptance criteria, and documentation items such as part name; NSN, serial/part number, government contract, DPAS rating, buying agency or company, contact info, delivery, inspection and buy-off criteria, quantity, lot info, classified status, roll-up assemblies or levels, means of/description of production, alternate inspection criteria, inspection method/equipment use, and calibration status, environmental or hazmat info, manufacturer/distributor/buyer/contract party/customer/military component CAGE codes, any DOD/DCMA or QAR inspection and acceptance info, RFID, military packaging, and labeling data.

According to some embodiments, certification documents may be based or modeled on the general format of MIL-HDBK-831 Preparation of Test Reports, MIL-STD-105E Sampling Procedures for Inspection by Attributes, MIL-STD-1916 DOD Test Method Standards, proposed or documented deep cryogenic AMS/ASTM or MIL-STDs, or other military First Article Tests or Certificates of Conformance.

In these embodiments, the output form of certification may be a written or digital (or both) certificate document that is issued by the manufacturer and/or authorized test facility approved to issue such a certification document. The document may be required to generate a First Article Test document or other necessary acceptance documents that state realization measurement of certain metallurgical property requirements. The validated AM cryogenically treated part is hence considered certified via certification of the proxy certified witness artifact.

What is claimed is:

1. A method of authenticating, testing and certifying additive manufactured and cryogenically treated additive manufactured parts comprising:
Producing a set of artifacts approximately simultaneous with the creation of the additive manufactured part.
Identifying the artifacts through various marking or ID methods.
Identifying a set of metallurgical characteristics of an additive manufactured part and then testing the artifact.
Authenticating the artifacts using a process that links the characteristics of the artifact manufacturing, by proxy, to the referenced part.
Testing and certifying the additive manufactured part via the artifact, if not cryogenically processed.
If cryogenically processed, separating the authenticated AM artifacts into control artifacts that represent “as additive manufactured” metallurgical characteristics and witness artifacts that reflect the changes to the article (part) and witness artifact after being cryogenically processed.
Cryogenically processing the referenced AM part and the AM witness part.
Validating the part, by proxy, through testing and documenting changes to the characteristics of the witness artifact as compared to the control artifact.
Certifying the referenced part by producing a First Article or other standards-based test certificate that certifies the part via the certified witness artifact.

2-12. (canceled)
